(19) United States
(12) Patent Application Publication
(10) Pub. No.: US 2015/0002768 A1
(43) Pub. Date: Jan. 1, 2015

(54) METHOD AND APPARATUS TO CONTROL OBJECT VISIBILITY WITH SWITCHABLE GLASS AND PHOTO-TAKING INTENTION DETECTION

(71) Applicant: 3M INNOVATIVE PROPERTIES COMPANY, St. Paul, MN (US)

(72) Inventor: SHUGUANG WU, AUSTIN, TX (US)

(21) Appl. No.: 13/927,264

(22) Filed: Jun. 26, 2013

(51) Int. Cl. G02F 1/133; G02F 1/01; G02B 26/02; G02F 1/163; G02F 1/167

(52) U.S. Cl. CPC G02F 1/13306; G02F 1/163; G02F 1/167; G02B 26/02; G02F 1/0121
USPC 349/16; 359/275; 359/296; 359/290; 359/238

(57) ABSTRACT

A system for controlling switchable glass based upon intention detection. The system includes a sensor for providing information relating to a posture of a person detected by the sensor, a processor, and switchable glass capable of being switched between transparent and opaque states. The processor is configured to receive the information from the sensor and process the received information in order to determine if an event occurred. This processing includes determining whether the posture of the person indicates a particular intention, such as attempting to take a photo. If the event occurred, the processor is configured to control the state of the switchable glass by switching it to an opaque state to prevent the photo-taking of an object, such as artwork, behind the switchable glass.

### BACKGROUND

A purpose of museums is to attract visitors to view their exhibit of artworks, or in a more general term, objects. At the same time, the museums have the responsibility to conserve and protect these objects. Many of the museums face the challenge of balancing the need to achieve both objectives in creating the right lighting environment. For example, a museum display case might provide the optimum light transmittance to correctly display objects while at the same time minimizing the deterioration to the objects resulting from incident light.

A switchable glass allows users to control the amount of light transmission through the glass. The glass can be switched between a transparent state and a translucent or opaque state upon activation. For example, PDLC (Polymer Dispersed Liquid Crystal) is a mixture of liquid crystal in a cured polymer network that is switchable between light transmitting and light scattering states. Other technologies used to create switchable glass include electrochromic devices, suspended particle devices, and micro-blinds.

Some museums have started to deploy display cases with switchable glass that enable the operators to control exposure to light by the artwork. The switchable glass is activated (changed to transparent state) either manually by a visitor pressing a button or automatically when a visitor is detected by a proximity or motion sensor. A need exists for more robust methods to control the switchable glass in museums or other environments.

### SUMMARY

A system for controlling switchable glass based upon intention detection, consistent with the present invention, includes switchable glass capable of being switched between a transparent state and an opaque state, a sensor for providing information relating to a posture of a person detected by the sensor, and a processor electronically connected with the switchable glass and sensor. The processor is configured to receive the information from the sensor and process the received information in order to determine if an event occurred. This processing involves determining whether the posture of the person indicates a particular intention. If the event occurred, the processor is configured to control the state of the switchable glass based upon the event.

A method for controlling switchable glass based upon intention detection, consistent with the present invention, includes receiving from a sensor information relating to a posture of a person detected by the sensor and processing the received information in order to determine if an event occurred. This processing step involves determining whether the posture of the person indicates a particular intention. If the event occurred, the method includes controlling a state of a switchable glass based upon the event, where the switchable glass is capable of being switched between a transparent state and an opaque state.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a system for customer interaction based upon intention detection;

FIG. 2 is a diagram representing ideal photo taking posture;

FIG. 3 is a diagram representing positions of an object, viewfinder, and eye in the ideal photo taking posture;

FIG. 4 is a diagram illustrating a detection algorithm for detecting a photo taking posture;

FIG. 5 is a flow chart of a method for customer interaction based upon intention detection;

FIG. 6 is a diagram of a system for object visibility blocking based upon photo-taking intention detection; and

FIG. 7 is a flow chart of a method for object visibility blocking based upon photo-taking intention detection.

### DETAILED DESCRIPTION

A system for photo-taking intention detection is described in U.S. patent application Ser. No. 13/681469, entitled “Human Interaction System Based Upon Real-Time Intention Detection,” and filed Nov. 20, 2012, which is incorporated herein by reference as if fully set forth.

### Intention Detection

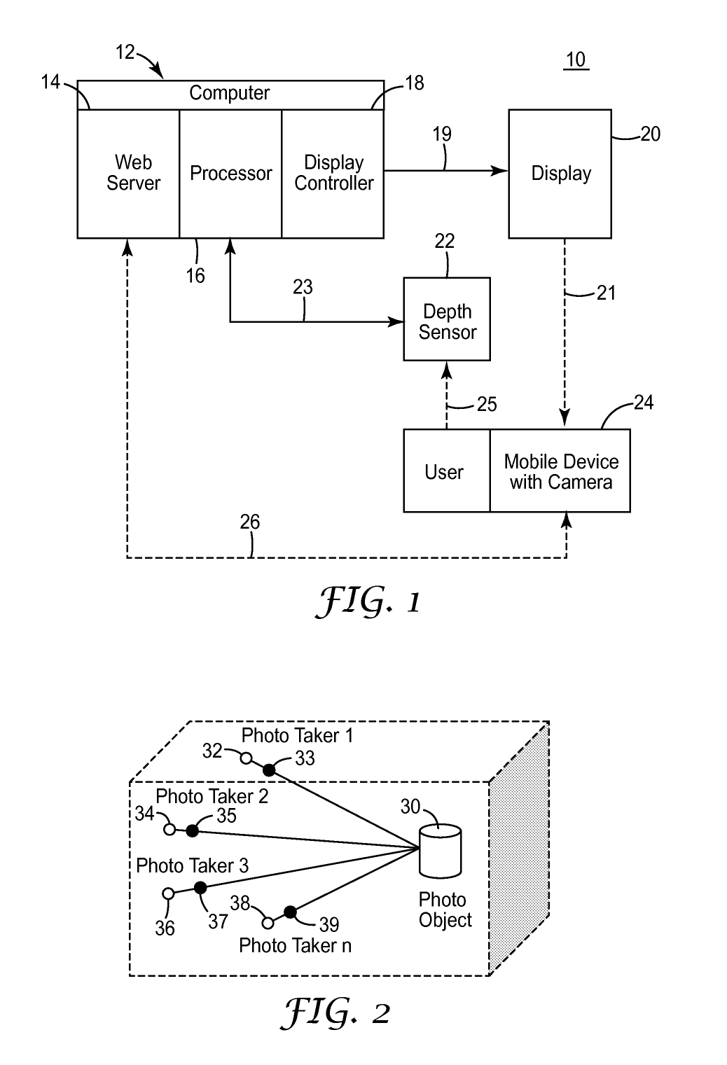

FIG. 1 is a diagram of a system 10 for customer interaction based upon intention detection. System 10 includes a computer 12 having a web server 14, a processor 16, and a display controller 18. System 10 also includes a display device 20 and a depth sensor 22. Examples of an active depth sensor include the KINECT sensor from Microsoft Corporation and the sensor described in U.S. Patent Application Publication No. 2010/0199228, which is incorporated herein by reference as if fully set forth. The sensor can have a small form factor and be placed discretely so as to not attract a customer's attention. Computer 10 can be implemented with, for example, a laptop personal computer connected to depth sensor 22 through a USB connection 23. Alternatively, system 10 can be implemented in an embedded system or remotely through a central server which monitors multiple displays. Display device 20 is controlled by display controller 18 via a connection 19 and can be implemented with, for example, an LCD device or other type of display (e.g., flat panel, plasma, projection, CRT, or 3D).

In operation, system 10 via depth sensor 22 detects, as represented by arrow 25, a user having a mobile device 24 with a camera. Depth sensor 22 provides information to computer 12 relating to the user's posture. In particular, depth sensor 22 provides information concerning the position and orientation of the user's body, which can be used to determine the user's posture. System 10 using processor 16 analyzes the user's posture to determine if the user appears to be taking a photo, for example. If such posture (intention) is detected, computer 12 can provide particular content on display device 20 relating to the detected intention, for example a QR code can be displayed. The user upon viewing the displayed content may interact with the system using mobile device 24 and a network connection 26 (e.g., Internet web site) to web server 14.

Display device 20 can optionally display the QR code with the content at all times while monitoring for the intention posture. The QR code can be displayed in the bottom corner, for example, of the displayed picture such that it does not interfere with the viewing of the main content. If intention is detected, the QR code can be moved and enlarged to cover the displayed picture.

In this exemplary embodiment, the principle of detecting a photo-taking intention (or posture) is based on the following observations. The photo taking posture is uncommon; therefore, it is possible to differentiate from normal postures such as customers walking by or simply watching a display. The photo taking postures from different people share some universal characteristics, such as the three-dimensional position of a camera relative to the head and eye and the object being photographed, despite different types of cameras and ways to use them. In particular, different people use their cameras differently, such as single-handed photo taking versus using two hands, and using an optical versus electronics viewfinder to take a photo. However, as illustrated in FIG. 2 where an object 30 is being photographed, photo taking postures tend to share the following characteristic: the eye(s), the viewfinder, and the photo object are roughly aligned along a virtual line. In particular, a photo taker 1 has an eye position 32 and viewfinder position 33, a photo taker 2 has an eye position 34 and viewfinder position 35, a photo taker 3 has an eye position 36 and viewfinder position 37, and a photo taker n has an eye position 38 and viewfinder position 39.

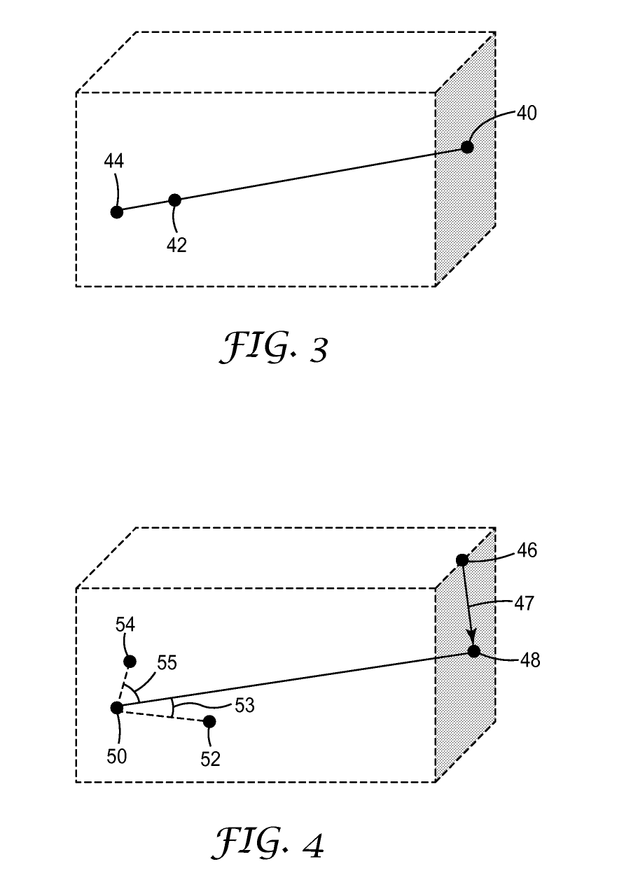

This observation is abstracted in FIG. 3, illustrating an object position 40 (P_{object}) of the object being photographed, a viewfinder position 42 (P_{viewfinder}), and an eye position 44 (P_{eye}). Positions 40, 42, and 44 are shown arranged along a virtual line for the ideal or typical photo taking posture. In an ideal implementation, sensing techniques enable precise detection of the positions of the camera viewfinder (P_{viewfinder}) or camera body as well as the eye(s) (P_{eye}) of the photo taker.

Embodiments of the present invention can simplify the task of sensing those positions through an approximation, as shown in FIG. 4, that maps well to the depth sensor positions. FIG. 4 illustrates the following for this approximation in three-dimensional space: a sensor position 46 (Pₛₑₙₛₒᵣ) for sensor 22; a display position 48 (P_{display}) for display device 20 representing a displayed object being photographed; and a photo taker's head position 50 (P_{head}), right hand position 52 (P_{rhand}), and left hand position 54 (P_{lhand}). FIG. 4 also illustrates an offset 47 (Δsensor_{_{—}}_{offset}) between the sensor and display positions 46 and 48, an angle 53 (θᵣₕ) between the photo taker's right hand and head positions, and an angles 55 (θₗₕ) between the photo taker's left hand and head positions.

The camera viewfinder position is approximated with the position(s) of the camera held by the photo taker's hand(s), P_{viewfinder}≈P_{hand} (P_{rhand} and P_{lhand}). The eye position is approximated with the head position, P_{head}≈P_{eye}. The object position 48 (center of display) for the object being photographed is calculated with the sensor position and a predetermined offset between the sensor and the center of display, P_{display}=Pₛₑₙₛₒᵣ+Δₛₑₙₛₒᵣ_{_{—}}_{offset}. Therefore, the system determines if the detected event has occurred (photo taking) when the head (P_{head}) an at least one hand (P_{rhand} or P_{lhand}) of the user form a straight line pointing to the center of display (P_{display}). Additionally, more qualitative and quantitative constraints can be added in spatial and temporal domains to increase the accuracy of the detection. For example, when both hands are aligned with the head-display direction, the likelihood of correct detection of photo taking is significantly higher. As another example, when the hands are either too close or too far away from the head, it may indicate different postures (e.g., pointing at the display) other than a photo taking event. Therefore, a hand range parameter can be set to reduce false positives. Moreover, since the photo-taking action is not instantaneous, a “persistence” period can be added after the first positive posture detection to ensure that such detection was not the result of false momentarily body or joint recognition by the depth sensor. The detection algorithm can determine if the user remains in the photo-taking posture for a particular time period, for example 0.5 seconds, to determine that an event has occurred.

In the real world the three points (object, hand, head) are not perfectly aligned. Therefore, the system can consider the variations and noise when conducting the intention detection. One effective method to quantify the detection is to use the angle between the two vectors formed by the left or right hand, head, and the center of display as illustrated in FIG. 4. The angle θₗₕ (55) or θᵣₕ (53) equals zero when the three points are perfectly aligned and will increase when the alignment decreases. An angle threshold Θ_{threshold} can be set to flag a positive or negative detection based on real-time calculation of such angle. The value of Θ_{threshold} can be determined using various regression or classification methods (e.g., supervised or unsupervised learning). The value of Θ_{threshold} can also be based upon empirical data. In this exemplary embodiment, the value of Θ_{threshold} is equal to 12°.

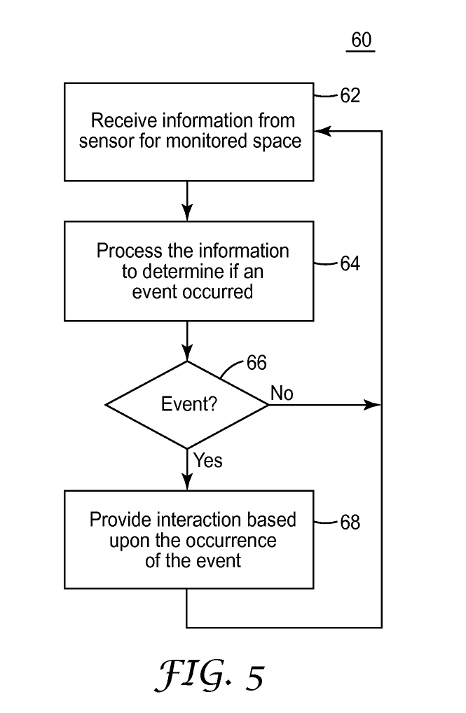

FIG. 5 is a flow chart of a method 60 for customer interaction based upon intention detection. Method 60 can be implemented in, for example, software for execution by processor 16 in system 10. In method 60, computer 10 receives information from sensor 22 for the monitored space (step 62). The monitored space is an area in front of, or within the range of, sensor 22. Typically, sensor 22 can be located adjacent or proximate display device 20 as illustrated in FIG. 4, such as above or below the display device, to monitor the space in front of or within as area where the display can be viewed.

System 10 processes the received information from sensor 22 in order to determine if an event occurred (step 64). As described in the exemplary embodiment above, the system can determine if a person in the monitored space is attempting to take a photo based upon the person's posture as interpreted by analyzing the information from sensor 22. If an event occurred (step 66), such as detection of a photo taking posture, system 10 provides interaction based upon the occurrence of the event (step 68). For example, system 10 can provide on display device 20 device a QR code, which when captured by the user's mobile device 24 provides the user with a connection to a network site such as an Internet web site where system 10 can interact with the user via the user's mobile device. Aside from a QR code, system 10 can display on display device 20 other indications of a web site such as the address for it. System 10 can also optionally display a message on display device 20 to interact with the user when an event is detected. As another example, system 10 can remove content from display device 20, such as an image of the user, when an event is detected.

Although this exemplary embodiment has been described with respect to a potential customer, the intention detection method can be used to detect the intention of others and interact with them as well.

Table 1 provides sample code for implementing the event detection algorithm in software for execution by a processor such as processor 16.

TABLE 1
Pseudo Code for Detection Algorithm

```
task photo_taking_detection( )
{
    Set center of display position P_{display}=(x_{d}, y_{d}, z_{d})= Pₛₑₙₛₒᵣ +
    Δₛₑₙₛₒᵣ_{_{—}}_{offset} ;
    Set angle threshold Θ_{threshold} ;
    while (people_detected & skeleton data available)
    {
        Obtain head position P_{head}= (xₕ, yₕ, zₕ) ;
        Obtain left hand position P_{lhand}= (xₗₕ, yₗₕ, zₗₕ) ;
        3D line vector V_{head-display}=P_{head}P_{display} ;
        3D line vector V_{head-lhand}= P_{head}P_{lhand} ;
        3D line vector V_{head-rhand}= P_{head}P_{rhand} ;
        Angle_LeftHand= 3Dangle(v_{head-display}, v_{head-lhand}) ;
        Angle_RightHand= 3Dangle(v_{head-display}, v_{head-rhand});
        if (Angle_LeftHand < Θ_{threshold} || Angle_RightHand <
        Θ_{threshold})
            return Detection_Positive;
    }
}
```

Intention Detection to Control Object Visibility

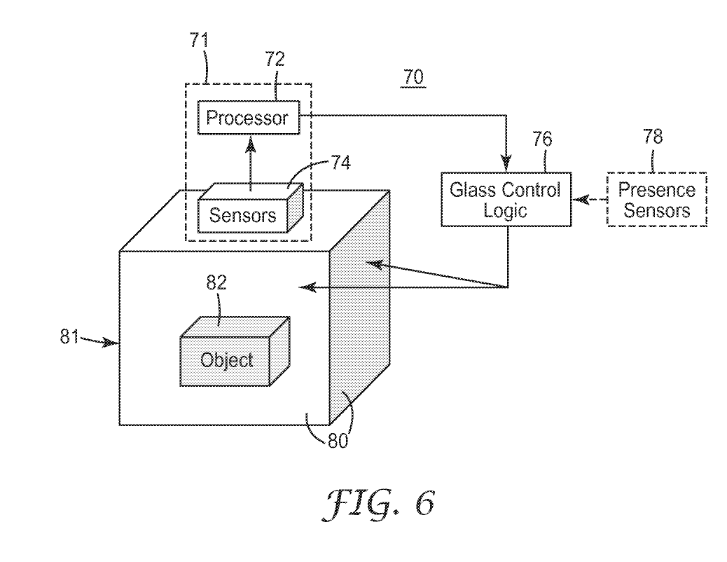

FIG. 6 is a diagram of a system 70 for object visibility blocking based upon photo-taking intention detection. An object 82 to be protected is contained within a display case 81, for example, having switchable glass sides 80. System 70 includes a photo-taking detection subsystem 71 having a processor 72 receiving signals from sensors 74. Glass control logic 76 receives signals from processor 72 and controls switchable glass 80. System 70 can optionally include presence sensors 78, coupled to glass control logic 76, for use in sensing the presence of a person proximate display case 81. Although only two sides of display case 81 are shown being controlled, display case 81 can include switchable glass on any number of its sides for control by glass control logic 76. Also, aside from a display case, system 70 can be used to control switchable glass in other configurations such as a window, table top, or panel with an object behind the switchable glass in those configurations from a viewer's perspective.

Sensors 74 can be implemented with a depth sensor, such as sensor 22 or other sensors described above. Switchable glass 80 can be implemented with any device that can be switched between a transparent state and an opaque state, for example PDLC displays or glass panels, electrochromic devices, suspended particle devices, or micro-blinds. The transparent state can include being at least sufficiently transparent to view an object through the glass, and the opaque state can include being at least sufficiently opaque to obscure a view of the object through the glass. Glass control logic 76 can be implemented with drivers for switching the states of glass 80. Presence sensors 78 can be implemented with, for example, a motion detector.

In use, processor 72 analyzes the sensor data from sensors 74 for real-time posture detection. Processor 72 in subsystem 71 generates an event when a photo-taking posture is positively detected. Such event is used as one input to switchable glass control logic 76 that provides the electronic signals to switch glass 80 from a transparent state to an opaque state. Presence sensors 78 can optionally be used in combination to the photo-taking detection subsystem.

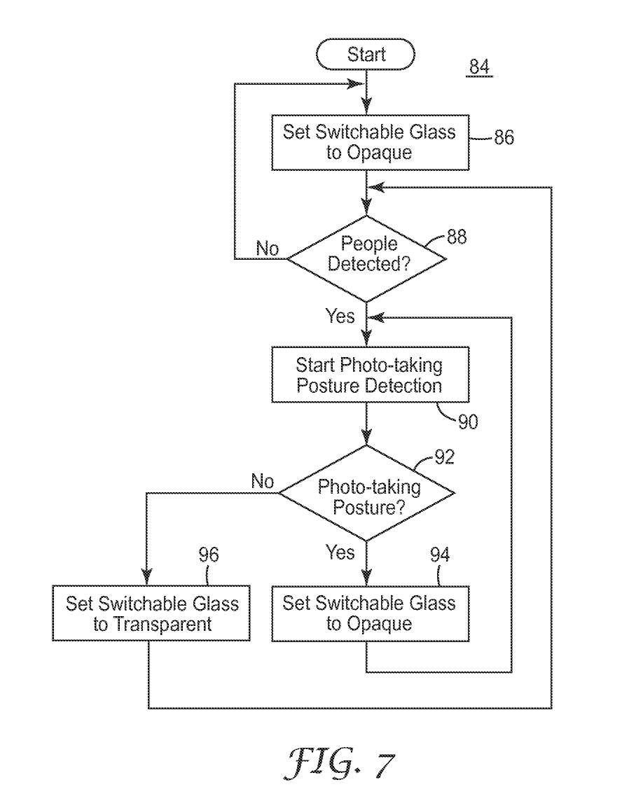

FIG. 7 is a flow chart of a method 84 for object visibility blocking based upon photo-taking intention detection. Method 84 can be implemented in, for example, software for execution by processor 72 in subsystem 71. In method 84, glass 80 is set to an opaque state by glass control logic 76 receiving a signal from processor 72 (step 86). System 70 determines if people are detected proximate or within the vicinity of (capable of viewing) display case 81 (step 88), and such detection can occur using sensors 74 or presence sensors 78, or both sensors 74 and 78. If people are detected, subsystem 71 starts photo-taking posture detection (step 90), which can be implemented with method 60 described above. If photo-taking posture is detected (step 92), glass 80 is set to an opaque state (step 94). Method 84 can optionally determine if the photo-taking posture is detected by determining if such posture exists for a particular time period, as described above with respect to a particular persistence period. If photo-taking posture is not detected (step 92), glass 80 is set to an transparent state (step 96). System 70 can optionally perform other actions if the photo-taking posture is detected such as displaying a warning message or other types of information.

This embodiment can thus enhance “smart glass” (switchable glass) applications. Such a system can be deployed by museums, for example, to protect their valuable exhibits from artificial light damage or copyright infringement, or simply to discourage behaviors that affect others. Other possible environments for the controllable switchable glass include art galleries, trade shows, exhibits, or any place where it is desirable to control the viewability or exposure of an object.

1. A system for controlling switchable glass based upon intention detection, comprising:
switchable glass capable of being switched between a transparent state and an opaque state;
a sensor for providing information relating to a posture of a person detected by the sensor; and
a processor electronically connected with the switchable glass and the sensor, wherein the processor is configured to:
receive the information from the sensor;
process the received information in order to determine if an event occurred by determining whether the posture of the person indicates a particular intention of the person; and
if the event occurred, control the state of the switchable glass based upon the event.

2. The system of claim 1, wherein the sensor comprises a depth sensor.

3. The system of claim 1, wherein the switchable glass comprises a PDLC glass panel.

4. The system of claim 1, wherein the switchable glass comprises an electrochromic device.

5. The system of claim 1, wherein the switchable glass comprises a suspended particle device.

6. The system of claim 1, wherein the switchable glass comprises micro-blinds.

7. The system of claim 1, wherein the processor is configured to determine if the posture indicates the person is attempting to take a photo.

8. The system of claim 1, wherein the processor is configured to determine if the event occurred by determining if the posture of the person persists for a particular time period.

9. The system of claim 1, wherein the switchable glass is part of display case having multiple sides with the switchable glass on one or more of the sides.

10. The system of claim 1, further comprising a presence sensor, coupled to the processor, for providing a signal indicating a person is within a vicinity of the switchable glass.

11. A method for controlling switchable glass based upon intention detection, comprising:
receiving from a sensor information relating to a posture of a person detected by the sensor;
processing the received information, using a processor, in order to determine if an event occurred by determining whether the posture of the person indicates a particular intention of the person; and
if the event occurred, controlling a state of a switchable glass based upon the event, wherein the switchable glass is capable of being switched between a transparent state and an opaque state.

12. The method of claim 11, wherein the receiving step comprises receiving the information from a depth sensor.

13. The method of claim 11, wherein the controlling step comprises controlling the state of a PDLC glass panel.

14. The method of claim 11, wherein the controlling step comprises controlling the state of an electrochromic device.

15. The method of claim 11, wherein the controlling step comprises controlling the state of a suspended particle device.

16. The method of claim 11, wherein the controlling step comprises controlling the state of micro-blinds.

17. The method of claim 11, wherein the processing step includes determining if the posture indicates the person is attempting to take a photo.

18. The method of claim 11, wherein the processing step includes determining if the event occurred by determining if the posture of the person persists for a particular time period.

19. The method of claim 11, further comprising receiving a signal from a presence sensor indicating a person is within a vicinity of the switchable glass.

20. The method of claim 19, further comprising controlling the switchable glass to be in the transparent state when the presence sensor indicates the person is within the vicinity.
